(19) United States
(12) Patent Application Publication
(10) Pub. No.: US 2017/0313288 A1
(43) Pub. Date: Nov. 2, 2017

(54) EXTERIOR VEHICLE CAMERA PROTECTION AND CLEANING MECHANISMS

(71) Applicant: Ford Global Technologies, LLC, Dearborn, MI (US)

(72) Inventors: David James Tippy, Ann Arbor, MI (US); Steven Yellin Schondorf, Dearborn, MI (US); Mahmoud Yousef Ghannam, Canton, MI (US)

(21) Appl. No.: 15/654,279

(22) Filed: Jul. 19, 2017

Related U.S. Application Data
(63) Continuation-in-part of application No. 15/099,117, filed on Apr. 14, 2016.

(51) Int. Cl. B60S 1/56; H04N 5/225; B60R 1/06; G02B 27/00; G03B 9/10; B60R 11/00

(52) U.S. Cl. CPC B60S 1/566; H04N 5/2254; H04N 5/2252; G03B 9/10; B60R 1/0602; G02B 27/0006; B60R 2011/004; B60R 2300/8093

(57) ABSTRACT

A vehicle camera protection and cleaning system is disclosed in which at least one wiper is positioned on an underside surface of a camera cover to clean a lens of a vehicle camera. In one embodiment, the system includes an inner ring fixedly attached to an underside surface of the cover, and a plurality of aperture members pivotally connected to the inner ring on one end and pivotally connected on another end to an outer gear that is movable relative to the inner gear, where at least one of the plurality of aperture members comprises a wiper configured to clean a lens of the camera when the aperture members are moved over the lens. In other embodiments, the wiper may be positioned on an underside surface of a cover of the camera that either rotates in a circular manner or translates over the lens of the camera.

### CROSS-REFERENCE TO RELATED APPLICATION

This application is a continuation-in-part of U.S. application Ser. No. 15/099,117, filed on Apr. 16, 2016, which is incorporated herein by reference in its entirety.

### BACKGROUND

This application relates generally to the field of camera protection and cleaning systems, and more particularly to systems and methods for protecting and cleaning external cameras mounted on a vehicle.

A Reversing Video Device (RVD) may be mounted on vehicles, such as an automobile, to assist a driver of the vehicle to avoid objects and people in the path of the vehicle when the vehicle is driven, such as in reverse. RVD systems may include a camera, such as a Rear View Camera (RVC), mounted on the vehicle to capture video of the scene surrounding the vehicle, and a video display unit mounted in the driver's line of sight to allow the driver to view the display when driving the vehicle.

Some mounting locations of a vehicle's camera, such as a rear view camera, may cause the camera's lens to collect dust, dirt, and debris, which may obscure the field of view of the camera. There exists a need, therefore, to provide a system that removes such dust, dirt, and debris to maintain the functionality of the camera or other externally facing device, such as a radar unit, while being easily accessible and maintainable by an owner of the vehicle.

### SUMMARY

A vehicle camera protection and cleaning system is disclosed. In one embodiment, the system includes an inner ring fixedly attached to an underside surface of the cover, and a plurality of aperture members pivotally connected to the inner ring on one end and pivotally connected on another end to an outer gear that is movable relative to the inner gear, where at least one of the plurality of aperture members comprises a wiper configured to clean a lens of the camera when the aperture members are moved over the lens.

The wiper may include a brush. The wiper may include a plastic or a rubber. The wiper may include a plurality of wiping elements configured to sweep across the lens of the camera.

The system may include a controller including a processor and memory configured to control the movement of the aperture members to clean the camera lens. The controller may control the movement of the aperture members over a predetermined period of time. The controller may control the movement of the aperture members in a predetermined cycle.

The aperture members may be positioned side by side along a circumference of the inner ring. The system may include a motor configured to rotate the outer gear.

In another embodiment, a vehicle camera protection and cleaning system is disclosed comprising a camera cover, the system comprising a motor connected to the cover and configured to rotate the cover in a circular manner, an aperture defined by a plurality of walls in the cover, the aperture configured to provide an opening for the camera for viewing a vicinity around a vehicle, and a plurality of wipers positioned on an undersigned surface of the cover, the wipers configured to clean a lens of the camera when the cover is moved over the lens.

The wiper may include a brush. The wiper may include a plastic or a rubber. The wiper may include a plurality of wiping elements configured to sweep across the lens of the camera.

The system may include a controller including a processor and memory configured to control the movement of the aperture members to clean the camera lens. The controller may control the movement of the aperture members over a predetermined period of time. The controller may control the movement of the aperture members in a predetermined cycle.

In another embodiment, a vehicle camera protection and cleaning system is disclosed comprising a camera cover, the system comprising a motor connected to the cover and configured to translate the cover over the camera lens, at least one wiper positioned on an undersigned surface of the cover, the at least one wiper configured to clean a lens of the camera when the cover is translated over the lens, and a controller including a processor and memory connected to the motor, the controller configured to control the movement of the cover over the camera lens.

The wiper may include a brush. The wiper may include a plastic or a rubber. The wiper may include a plurality of wiping elements configured to sweep across the lens of the camera.

### BRIEF DESCRIPTION OF THE DRAWINGS

FIG. 1A illustrates a top view of a vehicle of the instant disclosure.

FIG. 1B illustrates a rear view of the vehicle shown in FIG. 1A.

FIG. 2 illustrates a block diagram of exemplary components of the vehicle shown in FIG. 1A.

FIG. 3 illustrates a block diagram of an exemplary computing device operatively connected to the vehicle shown in FIG. 1A.

FIG. 4 illustrates a plan view of an embodiment of a camera cleaning and protection system of the instant disclosure with the cover shown in a first position.

FIG. 5 illustrates another plan view of the embodiment shown in FIG. 4 with the cover shown in a second position.

FIG. 6 illustrates another plan view of the embodiment shown in FIG. 4 with the cover shown in a third position.

FIG. 7 illustrates a perspective view of the embodiment shown in FIG. 4 with the cover removed.

FIG. 8 illustrates a plan view of another embodiment of a camera cleaning and protection system of the instant disclosure with the cover shown in a first position.

FIG. 9 illustrates another plan view of the embodiment shown in FIG. 8 with the cover shown in a second position.

FIG. 10 illustrates another plan view of the embodiment shown in FIG. 8 with the cover shown in a third position.

FIG. 11 illustrates a perspective view of an aspect of the embodiment shown in FIG. 8.

FIG. 12 illustrates a series of plan views of another embodiment of a camera cleaning and protection system of the instant disclosure with the cover shown in a first, second, third, and fourth position, respectively.

FIG. 13 illustrates a perspective view of an aspect of the embodiment shown in FIG. 12.

FIG. 14 illustrates a schematic view showing one or more modes of operation of a camera cleaning and protection system of the instant disclosure.

FIG. 15 illustrates another schematic view showing one or more modes of operation of a camera cleaning and protection system of the instant disclosure.

FIG. 16 illustrates a plan view of another example camera cleaning and protection system of the instant disclosure.

FIG. 17 illustrates a plan view of an example cover of the camera cleaning and protection system of FIG. 16.

FIG. 18 illustrates a plan view of another example camera cleaning and protection system of the instant disclosure.

FIG. 19 illustrates a schematic view showing one or more modes of operation of the camera cleaning and protection system of FIGS. 16-17 and/or FIG. 18.

### DETAILED DESCRIPTION

Although the figures and the instant disclosure describe one or more embodiments of a camera washing system, one of ordinary skill in the art would appreciate that the teachings of the instant disclosure would not be limited to these embodiments.

Turning now to the drawings wherein like reference numerals refer to like elements, there are shown exemplary embodiments and methods of a camera cleaning and protection system for a vehicle camera or other device that may collect dust, dirt, and/or debris for which cleaning may be useful.

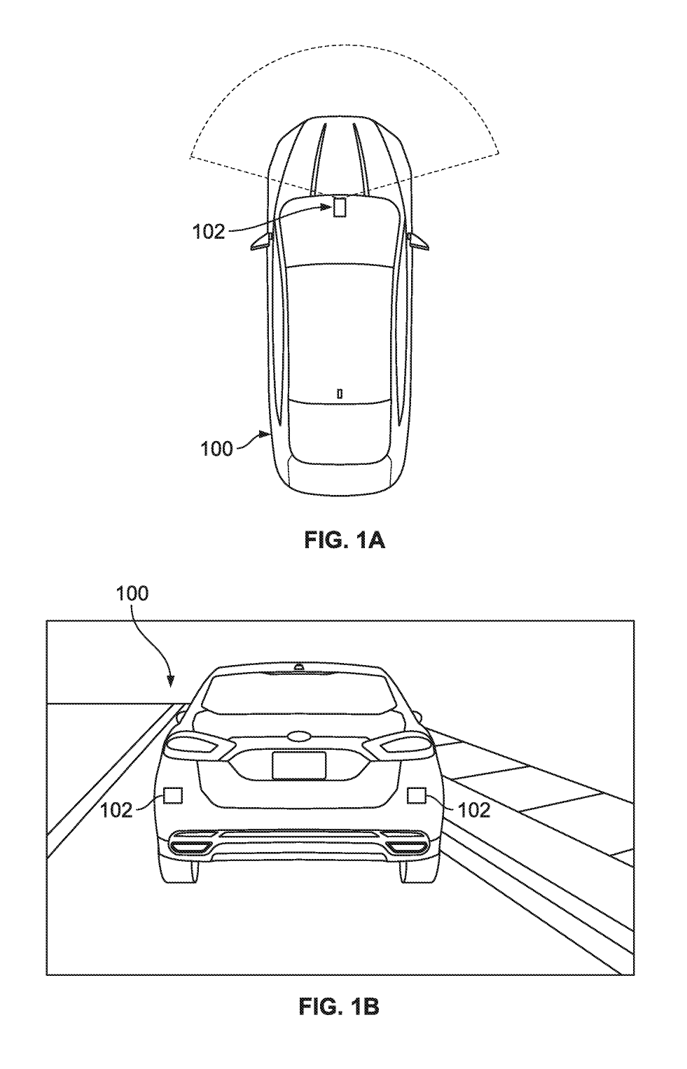

FIGS. 1A-1B show vehicle 100 in accordance with one embodiment of the instant disclosure. In this embodiment, vehicle 100 is an automobile, though in other embodiments vehicle 100 may be any suitable vehicle (such as a truck, a watercraft, or an aircraft). Vehicle 100 may be a gasoline powered vehicle, a hybrid vehicle, an electric vehicle, a fuel cell vehicle, or any other type of suitable vehicle. Vehicle 100 may include standard features, such as a dashboard, adjustable seats, one or more batteries, an engine or motor, a transmission, an HVAC system including a compressor and electronic expansion valve, a windshield and/or one or more windows, doors, a rear view mirror, a right side view mirror, a left side view mirror, seatbelts, airbags, wheels, and tires.

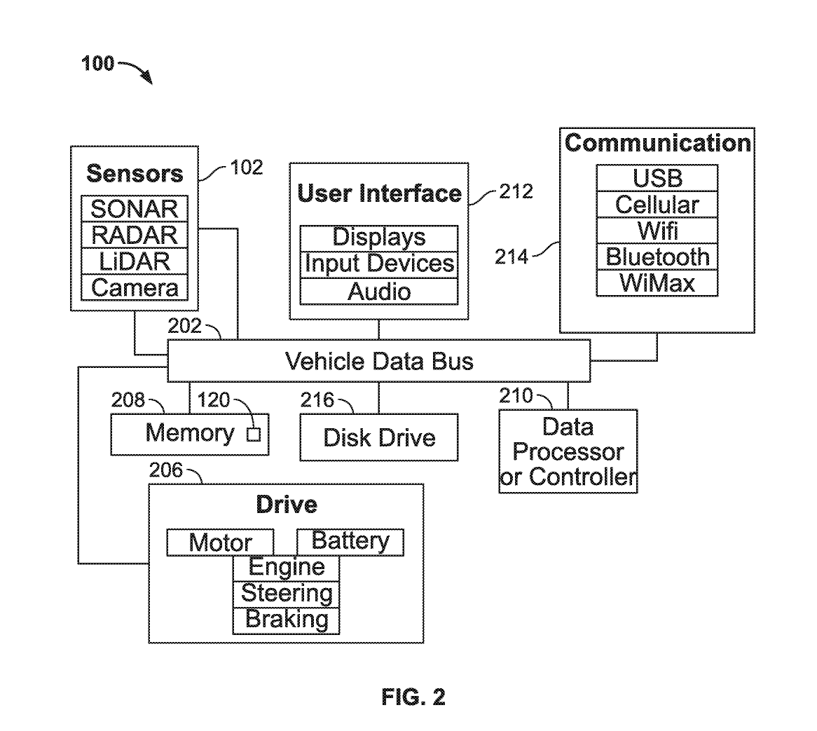

As shown in FIGS. 1A-1B and 2, vehicle 100 may include sensors 102, which may be arranged in and around the vehicle in a suitable fashion. Sensors 102 can all be the same or they can vary from one to the next. Sensors 102 may include many sensors or only a single sensor.

Certain of the sensors 102 may be configured to obtain data about the environment surrounding the vehicle (e.g., position sensors or weather sensors), as indicated by the dashed line in FIG. 1A, while others obtain data about components of the vehicle itself (e.g., gas level sensors or oil pressure sensors). The sensors 102 may be configured to transmit the data they obtain to one or more controllers of the vehicle 100, such as to controller 210 (described below), for further processing. The sensors 102 may include any suitable sensor or sensors such as, but not limited to: (1) infrared sensors; (2) visual sensors (such as cameras); (3) ultrasonic sensors; (4) RADAR; (5) LIDAR; (6) laser-scan sensors; (7) inertial sensors (for example, an inertial measurement unit); (8) wheel speed sensors; (9) road condition sensors (to directly measure certain road conditions); (10) rain sensors; (11) suspension height sensors; (12) steering wheel angle sensors; (13) steering torque sensors; (14) brake pressure sensors; (15) tire pressure sensors; or (16) vehicle location or navigation sensors (such as a Global Positioning System). Sensors 102 may include gear sensors configured to detect gear engagement of the vehicle's transmission, accelerometers configured to detect vehicle acceleration, speed sensors to detect vehicle speed, wheel speed, and/or steering wheel speed, torque sensors to detect engine or motor output torque, driveline torque, and/or wheel torque, and position sensors to detect steering wheel angular position, brake pedal position, and/or mirror position. Some sensors 102 may be mounted inside the passenger compartment of vehicle 100, around the exterior of the vehicle, or in the engine compartment of vehicle 100. At least one sensor 102 may be used to identify the vehicle's driver via facial recognition, speech recognition, or communication with a device, such as a vehicle key or mobile phone personal to the driver.

Sensors 102 may have an OFF state and various ON states. Vehicle 100, or a device operatively connected to the vehicle, may be configured to control the states or activity of the sensors. It should be appreciated that the term “internal sensors” includes all sensors mounted to the vehicle, including sensors that are mounted to an exterior of vehicle 100.

As shown in FIG. 2, in one embodiment, vehicle 100 includes a vehicle data bus 202 operatively coupled to sensors 102, vehicle drive devices 206, memory or data storage 208, a processor or controller 210, a user interface 212, communication devices 214, and a disk drive 216.

The processor or controller 210 may be any suitable processing device or set of processing devices such as, but not limited to: a microprocessor, a microcontroller-based platform, a suitable integrated circuit, or one or more application-specific integrated circuits (ASICs).

The memory 208 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.); unalterable memory (e.g., EPROMs); read-only memory; a hard drive; a solid state hard drive; or a physical disk such as a DVD. In an embodiment, the memory includes multiple kinds of memory, particularly volatile memory add non-volatile memory.

The communication devices 214 may include a wired or wireless network interface to enable communication with an external network. The external network may be a collection of one or more networks, including standards-based networks (e.g., 2G, 3G, 4G, Universal Mobile Telecommunications Autonomous valet parking system (UMTS), GSM® Association, Long Term Evolution (LTE)™, or more); WMAX; Bluetooth; near field communication (NFC); WFi (including 802.11 a/b/g/n/ac or others); WiGig; Global Positioning System (GPS) networks; and others available at the time of the filing of this application or that may be developed in the future. Further, the external network(s) may be a public network, such as the Internet; a private network, such as an intranet; or combinations thereof, and may utilize a variety of networking protocols now available or later developed including, but not limited to, TCP/IP-based networking protocols. The communication devices 214 may also include a wired or wireless interface to enable direct communication with an electronic device, such as a USB or Bluetooth interface.

The user interface 212 may include any suitable input and output devices. The input devices enable a driver or a passenger of vehicle 100 to input modifications or updates to information shown in, for example, a vehicle display. The input devices may include, for instance, a control knob, an instrument panel, a keyboard, a scanner, a digital camera for image capture and/or visual command recognition, a touch screen, an audio input device (e.g., cabin microphone), buttons, a mouse, or a touchpad. The output devices may include instrument cluster outputs (e.g., dials, lighting devices), actuators, a display (e.g., a liquid crystal display (“LCD”), an organic light emitting diode (“OLED”), a flat panel display, a solid state display, a cathode ray tube (“CRT”), or a heads-up display), and speakers. It should be appreciated that the term pressing a button or feature also includes pressing or activating a virtual button or feature, such as using a mouse to click on an item on a display, or pressing a virtual button on a touch screen.

The disk drive 216 is configured to receive a computer readable medium. In certain embodiments, the disk drive 216 receives the computer-readable medium on which one or more sets of instructions. The instructions may embody one or more of the methods or logic as described herein. In a particular embodiment, the instructions may reside completely, or at least partially, within any one or more of the main memory 208, the computer readable medium, and/or within the processor 210 during execution of the instructions.

The term “computer-readable medium” should be understood to include a single medium or multiple media, such as a centralized or distributed database, and/or associated caches and servers that store one or more sets of instructions. The term “computer-readable medium” also includes any tangible medium that is capable of storing, encoding or carrying a set of instructions for execution by a processor or that cause a system to perform any one or more of the methods or operations disclosed herein.

In one embodiment, the vehicle 100 includes a one or more computer programs or subprograms 120 stored in the memory 208. When executed by the processor, the one or more computer programs or subprograms generate or select instructions for other elements of the vehicle to perform. In various embodiments, the one or more computer programs or subprograms are configured to direct instructions to the user interface 212, the communication devices 214, the vehicle drive 206, the sensors 102, the processor 210, and any other component operatively connected to the vehicle data bus 202. It should be appreciated that vehicle 100 may be fully autonomous or partially autonomous.

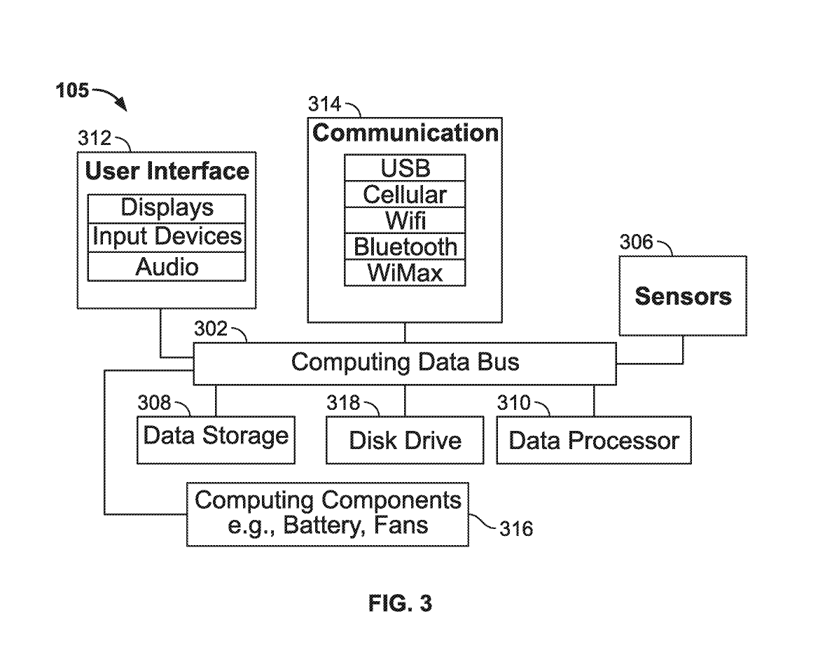

In various embodiments, a computing device 105 is operatively connected to the vehicle 100 via any suitable data connection such as WFi, Bluetooth, USB, or a cellular data connection. In one embodiment, shown in FIG. 3, the computing device 105 includes a data bus 302, operatively coupled to sensors 306, components 316, memory or data storage 308, a processor or controller 310, a user interface 312, and communication devices 314. It should be appreciated that the features of the computing device 105 may be similar to the features of the vehicle 100 as described above. For example, the communication devices 314 of the computing device 105 may operate similar to the communication devices 214 of the vehicle 100. The same applies to the user interface 312, the sensors 306, the data storage 308, the processor 310, and the disk drive 318. In various embodiments, the computing device 105 is a mobile phone or a server.

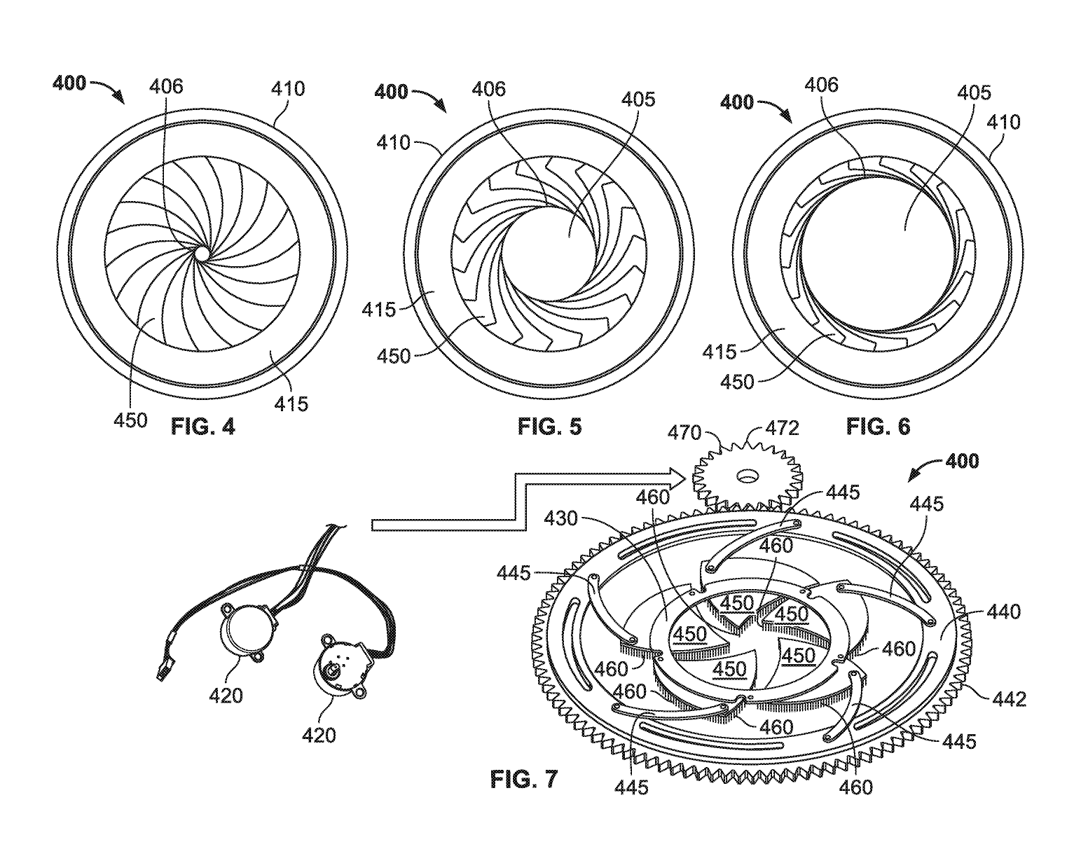

Turning to FIGS. 4-7, there is shown an exemplary camera cleaning and protection system 400 to wipe or clean a vehicle camera lens of a vehicle mounted or mountable camera. In this embodiment, camera protection and cleaning system 400 includes cover 410 comprising a cover housing 415, motor 420, inner ring 430 fixedly connected to an underside surface of cover housing 415, outer ring 440, shades 450 hingedly connected to inner ring 430 on one end and on another end to outer ring 440 via respective pivot members 445, one or more wipers 460 positioned on an underside of one or more shades 450, gear 470 configured to rotate outer ring 440, and an electronic controller (not shown) having a processor and memory configured to control the operation of motor 420. In some embodiments, camera protection and cleaning system 400 may include a sensor for detecting dirt or debris positioned on camera lens 405. In such embodiments, the sensor may include an optical sensor, a proximity sensor, or any other sensor configured to detect dirt or debris on camera lens 405. In this embodiment, although FIGS. 4-6 show at total of 18 shades 450, camera protection and cleaning system 400 may include any number of shades 450, such as the 5 shades 450 that are shown in FIG. 7, without departing from the instant disclosure.

The cover housing 415 includes an aperture 406, which permits an unobstructed view for the optics of the vehicle camera to capture the scene in the vicinity of vehicle 100. Cover housing 415 is configured to be detachably connected to the camera to easily remove and replace worn components of camera protection and cleaning system 400, including the one or more wipers 460.

The one or more wipers 460 may be configured as a brush having bristles, a squeegee, a pad, or any other configuration or combination that wipes away dirt and/or debris from the face of camera lens 405. In various embodiments, the one or more wipers 460 may be made from a nylon, a polyethylene, or other plastic, a naturally occurring fiber, a foam, an elastic and/or resilient material such as a rubber including natural rubber or a synthetic rubber, or any other material that serves the purpose of wiping away dirt and/or debris from the face of camera lens 405.

In this embodiment, gear teeth 472 of gear 470 are configured to be engaged with gear teeth 442 of outer ring 440. When commanded by a driver of vehicle 100 or automatically via the electronic controller, motor 420, which may be a stepper motor, may be configured to actuate and therefore cause rotation of gear 470. In so doing, gear 440 turns in the opposite direction of gear 470, causing shades 450 to move in unison in a spiral-like manner either to form aperture 406 over camera lens 405 or to close aperture 406 and therefore form a cover over camera lens 405. During the opening and closing movement of shades 450, the one or more wipers 460 may be configured to sweep across camera lens 405, thereby sweeping away dirt, debris or other impediments to viewing an image or scene through camera lens 405. FIG. 4, for example, shows aperture 406, which is defined by the position of shades 450, in a closed or mostly closed position. FIG. 6, by contrast, shows aperture 406, which is defined by a different position of shades 450, in an open or mostly open position. FIG. 5 shows a size of aperture 406 that lies between the size shown in FIGS. 4 and 6 during transit of shades 450 toward either a closed position or an open position.

In one embodiment, motor 420 is configured to rotate gear 470 in a pre-programmed pattern or sequence so as to repeatedly and at least partially open and close aperture 406 over camera lens 405 to repeatedly or sequentially sweep multiple wipers 460 back and forth over camera lens 405. In other embodiments, motor 420 is configured to rotate gear 470 in a pre-programmed pattern so as to either open or close the aperture over camera lens 405, and therefore, cause wipers 460 to sweep over camera lens 405 in a single pass. In other embodiments, wipers 460 may be commanded to make any number of passes over camera lens 405 to remove dirt or debris. In some embodiments, motor 420 is activated for a predetermined period of time, such as 5 seconds, 10 seconds, 20 seconds, or any other period of time, to cause wipers 460 to sweep over and clean camera lens 405. In yet other embodiments, a fluid, such as a cleaning fluid or a glass cleaner, may be dispensed, either manually or automatically, to aid in the dispersion and/or removal of dirt and/or debris from the surface of camera lens 405. In some embodiments, camera protection and cleaning system 400 may be configured to utilize the sensor to detect whether dirt or debris exists on the camera lens 405 to cease sweeping wipers 460 over camera lens 405 when the sensor no longer detects dirt or debris on the camera lens 405 or when the amount of dirt or debris detected on the camera lens 405 falls below a predetermined threshold.

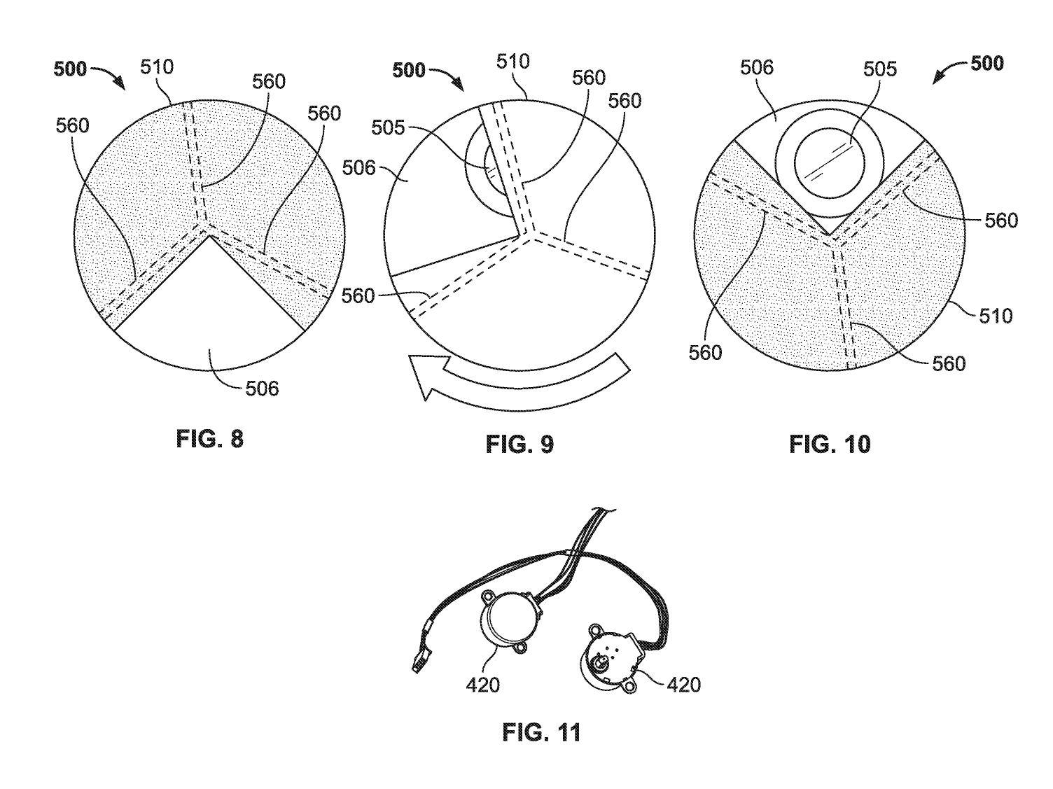

Turning to FIGS. 8-11 there is shown another embodiment of a camera protection and cleaning system. In this embodiment, camera protection and cleaning system 500 includes cover 510 comprising a fixed aperture 506, motor 420, one or more wipers 560 positioned on an underside of the cover 510, and an electronic controller (not shown) having a processor and memory configured to control the operation of motor 420. Camera protection and cleaning system 500 may include a sensor for detecting dirt or debris positioned on camera lens 505. The sensor may include an optical sensor, a proximity sensor, or any other sensor configured to detect dirt or debris on the camera lens. In this embodiment, although FIGS. 8-10 show at total of 3 wipers 560, camera protection and cleaning system 500 may include any number of wipers 560.

The cover 510 includes an aperture 506, which permits an unobstructed view for the optics of the vehicle camera to capture the scene in the vicinity of vehicle 100 when the aperture 506 is positioned over the vehicle camera. Cover 510 is configured to be detachably connected to the camera to easily remove and replace worn components of camera protection and cleaning system 500, including the one or more wipers 560.

The one or more wipers 560 may be configured as a brush having bristles, a squeegee, a pad, or any other configuration or combination that wipes away dirt and/or debris from the face of camera lens 505. In various embodiments, the one or more wipers 560 may be made from a nylon, a polyethylene, or other plastic, a naturally occurring fiber, a foam, an elastic and/or resilient material such as a rubber including natural rubber or a synthetic rubber, or any other material that serves the purpose of wiping away dirt and/or debris from the face of camera lens 505.

In this embodiment, when commanded by a driver of vehicle 100 or automatically via the electronic controller, motor 420, which may be a stepper motor, may be configured to actuate and therefore cause rotation of cover 510 in either a clockwise or counter-clockwise direction. In so doing, the one or more wipers 560 are moved across camera lens 505 to sweep away dirt, debris or other impediments to viewing an image or scene through camera lens 405. The rotation of cover 510 may be commanded, for example, when a driver of vehicle 100 engages the reverse gear in the vehicle's transmission, which may trigger a controller request to open the aperture 506 of a vehicle backup camera.

In one embodiment, motor 420 is configured to rotate cover 510 in a pre-programmed manner so as to repeatedly or sequentially sweep multiple wipers 560 over camera lens 505. In one embodiment, wipers 560 are swept back and forth over camera lens 505. In other embodiments, wipers 560 are configured to rotate in either a clockwise or counter-clockwise direction across camera lens 505 for a predetermined period of time. In some embodiments, motor 420 is activated for a predetermined period of time, such as 5 seconds, 10 seconds, 20 seconds, or any other period of time, to cause wipers 560 to sweep over and clean camera lens 505. In some embodiments, wipers 560 may be caused to sweep over camera lens 505 in a single pass. In other embodiments, wipers 560 may be commanded to make any number of passes over camera lens 505 to remove dirt or debris. In yet other embodiments, a fluid, such as a cleaning fluid or a glass cleaner, may be dispensed, either manually or automatically, to aid in the dispersion and/or removal of dirt and/or debris from the surface of camera lens 505.

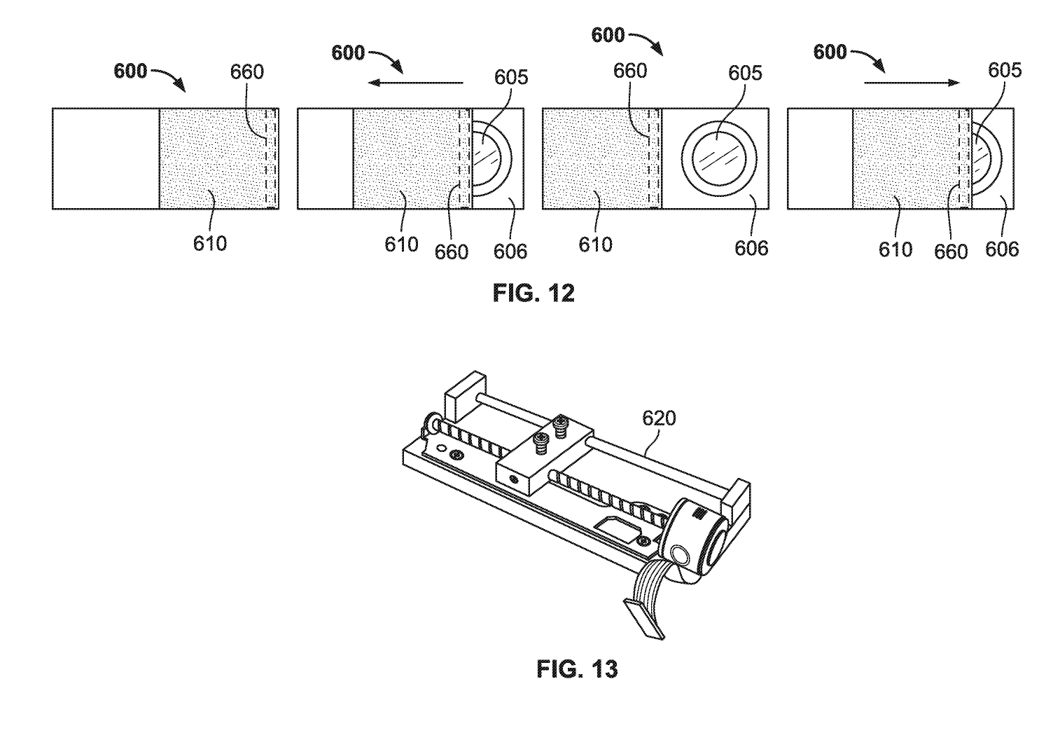

Turning to FIGS. 12-13 there is shown another embodiment of a camera protection and cleaning system. In this embodiment, camera protection and cleaning system 600 includes cover 610, motor 620, one or more wipers 660 positioned on an underside of the cover 610, and an electronic controller (not shown) having a processor and memory configured to control the operation of motor 420. Camera protection and cleaning system 600 may include a sensor for detecting dirt or debris positioned on camera lens 605. The sensor may include an optical sensor, a proximity sensor, or any other sensor configured to detect dirt or debris on the camera lens. In this embodiment, although FIG. 12 shows only wiper 660, camera protection and cleaning system 600 may include any number of wipers 660.

The cover 610 is configured to form an aperture 606, which permits an unobstructed view for the optics of the vehicle camera to capture the scene in the vicinity of vehicle 100, when the cover 610 is positioned so as to reveal or expose the vehicle camera. Cover 610 is configured to be detachably connected to the camera to easily remove and replace worn components of camera protection and cleaning system 600, including the one or more wipers 660.

The one or more wipers 660 may be configured as a brush having bristles, a squeegee, a pad, or any other configuration or combination that wipes away dirt and/or debris from the face of camera lens 605. In various embodiments, the one or more wipers 660 may be made from a nylon, a polyethylene, or other plastic, a naturally occurring fiber, a foam, an elastic and/or resilient material such as a rubber including natural rubber or a synthetic rubber, or any other material that serves the purpose of wiping away dirt and/or debris from the face of camera lens 605.

In this embodiment, when commanded by a driver of vehicle 100 or automatically via the electronic controller, motor 620, which may be a linear motor, may be configured to actuate and therefore cause lateral or translational movement of cover 610. In other embodiments, cover 610 is configured to be retractably rolled up on a reel or roller to reveal the vehicle camera, and unrolled and extended to cover the vehicle camera when not in use. In these embodiments, the one or more wipers 660 are translatably moved across camera lens 605 to sweep away dirt, debris or other impediments to viewing an image or scene through camera lens 605. The movement of cover 610 may be commanded, for example, when a driver of vehicle 100 engages the reverse gear in the vehicle's transmission.

In one embodiment, motor 620 is configured to move or translate cover 610 in a pre-programmed manner so as to repeatedly or sequentially sweep one or more wipers 660 over camera lens 605. In one embodiment, wipers 660 are translated back and forth over camera lens 605. In other embodiments, wipers 660 are configured to translate across camera lens 505 for a predetermined period of time. In some embodiments, motor 620 is activated for a predetermined period of time, such as 5 seconds, 10 seconds, 20 seconds, or any other period of time, to cause wipers 660 to translate over and clean camera lens 605. In some embodiments, wipers 660 may be commanded to translate over camera lens 505 in a single pass. In other embodiments, wipers 560 may be commanded to make any number of passes over camera lens 605 to remove dirt or debris. In yet other embodiments, a fluid, such as a cleaning fluid or a glass cleaner, may be dispensed, either manually or automatically, to aid in the dispersion and/or removal of dirt and/or debris from the surface of camera lens 605.

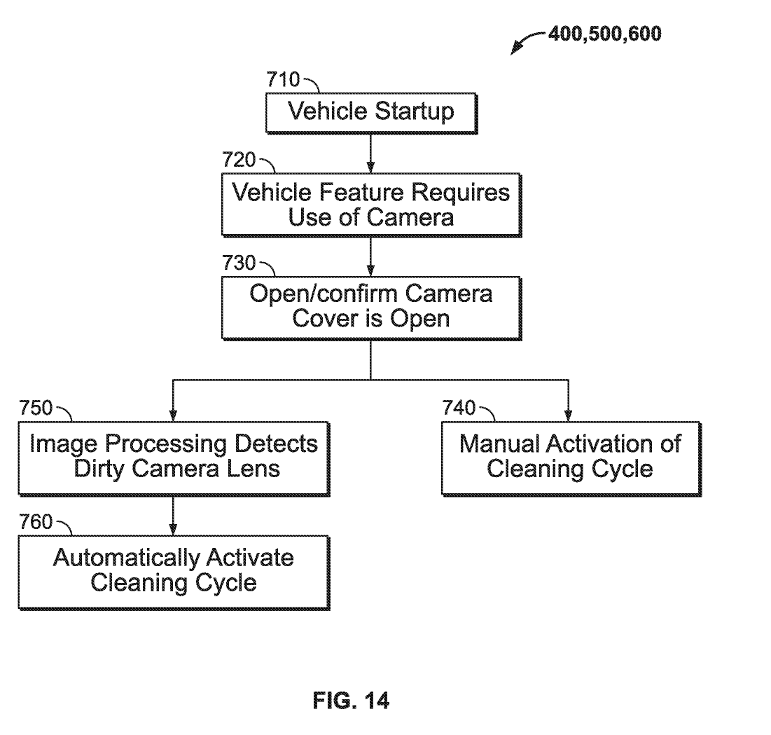

Turning to FIG. 14 there is shown an embodiment of a process for cleaning a vehicle camera lens. In this embodiment, on vehicle startup at step 710, one or more modules or systems of the vehicle 100 determines that one or more vehicle cameras should be activated, as shown at step 720. For example, when a driver of vehicle 100 engages the reverse gear in the vehicle's transmission, one or more electronic modules may trigger a controller to request activation of a camera. At step 730, camera protection and cleaning system 400,500,600 may be commanded by the controller to either open the camera cover (such as cover 410,510,610) or confirm that the camera cover is in an open position to expose the camera lens. At step 740, a driver of vehicle 100 may manually activate using, for example, a button or switch positioned within reach of the driver on the dashboard or console, if for example the driver determines that the camera lens appears dirty when viewing the scene in the vicinity of the vehicle on an electronic display. Once activated by a driver, camera protection and cleaning system 400,500,600 is configured to wipe away dirt or debris from the camera lens as disclosed above.

Steps 750 and 760 illustrate optional automatic operation of camera protection and cleaning system 400,500,600. At step 750, for example, camera protection and cleaning system 400,500,600 may be configured to detect whether the camera lens is dirty using an image processing system, which may include an imager or sensor as discussed above to detect a level of dirt or debris existing on the surface of the camera lens or a relative transparency or clarity of the lens.

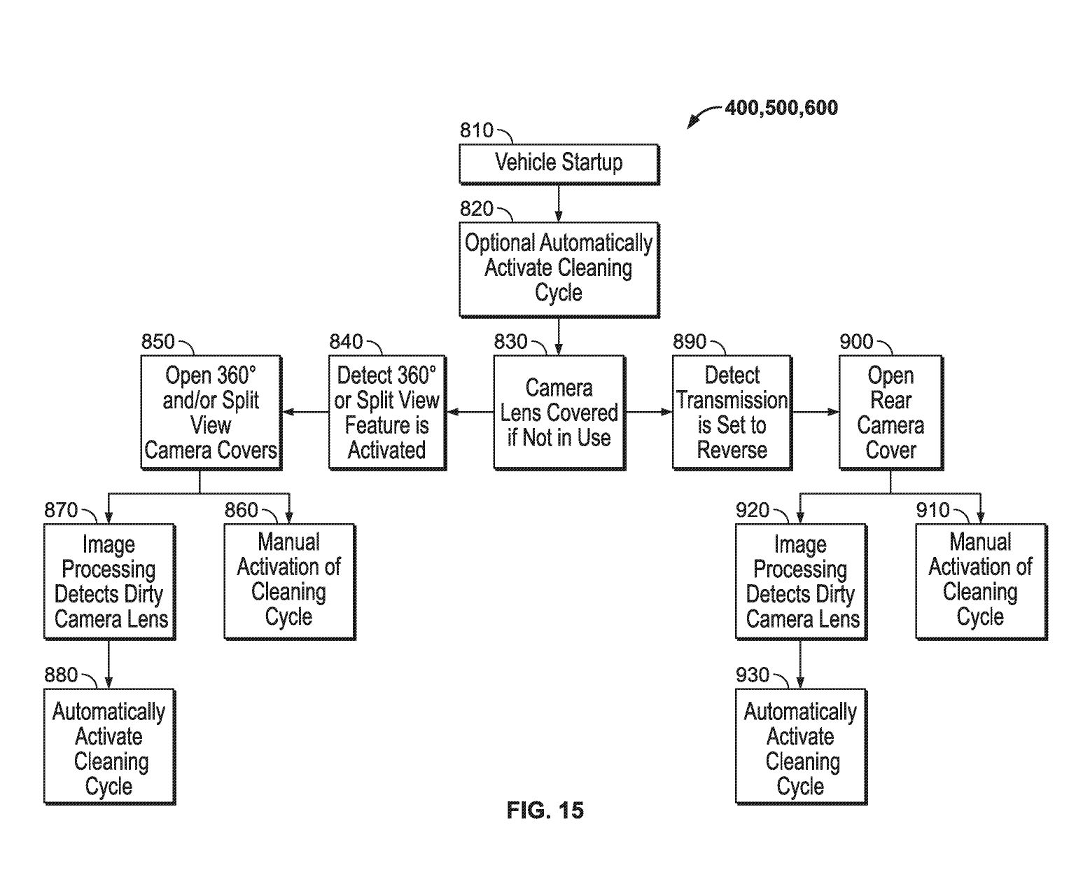

Turning to FIG. 15 there is shown another embodiment of a process for cleaning a vehicle camera lens. In this embodiment, on vehicle startup at step 810, camera protection and cleaning system 400,500,600 at step 820 may be configured to automatically initiate and complete a predetermined cleaning cycle of the camera lens. When the camera is not in use, the camera cover may be commanded to cover the camera lens to protect the lens from damage or debris, as shown at step 830.

In one aspect, when one or more modules of the vehicle 100 commands the operation of one or more vehicle 360° cameras or a split view cameras as shown at step 840, then camera protection and cleaning system 400,500,600 may be configured at step 850 to command the opening of one or more camera covers that may be covering the lens of the one or more 360° cameras or a split view cameras. If a driver at step 860 determines that the scene in the vicinity of the vehicle is obscured when viewing on an electronic display, the driver may manually activate camera protection and cleaning system 400,500,600 to initiate and complete a cleaning cycle of the camera lens.

Alternatively, steps 870 and 880 illustrate optional automatic operation of camera protection and cleaning system 400,500,600. At step 870, for example, camera protection and cleaning system 400,500,600 may be configured to detect whether the camera lens is dirty using an image processing system, which may include an imager or sensor as discussed above to detect a level of dirt or debris existing on the surface of the camera lens or a relative transparency or clarity of the lens. If the dirtiness of the camera lens exceeds a predetermined threshold, at step 880, camera protection and cleaning system 400,500,600 may be configured to initiate a predetermined cleaning cycle of the camera lens. In such instances, the cycle may include a predetermined cleaning sequence, a predetermined period of time of operation, or both.

In other embodiments, the camera protection and cleaning system 400,500,600 may be configured to either detect or receive a signal indicative of a driver engaging a transmission gear, such as a reverse gear, as shown at step 890. In that event, camera protection and cleaning system 400,500,600 may be configured at step 900 to command the opening of one or more camera covers that may be covering the lens of the one or more rear view cameras. If a driver at step 910 determines that the scene in the vicinity of the vehicle is obscured when viewing the scene on an electronic display, the driver may manually activate camera protection and cleaning system 400,500,600 to initiate and complete a cleaning cycle of the camera lens.

Alternatively, steps 920 and 930 illustrate optional automatic operation of camera protection and cleaning system 400,500,600. At step 920, for example, camera protection and cleaning system 400,500,600 may be configured to detect whether the rear view camera lens is dirty using an image processing system, which may include an imager or sensor as discussed above to detect a level of dirt or debris existing on the surface of the camera lens or a relative transparency or clarity of the lens. If the dirtiness of the camera lens exceeds a predetermined threshold, at step 930, camera protection and cleaning system 400,500,600 may be configured to initiate a predetermined cleaning cycle of the camera lens. In such instances, the cycle may include a predetermined cleaning sequence, a predetermined period of time of operation, or both.

In any embodiment, if one or more vehicle camera lenses is not cleanable to a desired level due to an excessive amount or type of debris, one or more electronic control units connected to or associated with camera protection and cleaning system 400,500,600 may be configured to digitally process the acquired images or video to enhance the quality of the resulting images or video and/or to exclude such debris from the resulting images and video that is displayed to the driver. In addition, camera protection and cleaning system 400,500,600 may be configured to detect whether shades 450 or covers 510,610 are jammed or not in their expected position when commanded to move and to provide a message the driver accordingly. Camera protection and cleaning system 400,500,600 may also be configured to detect environmental conditions, such as sandstorms and the like, and provide a message to the driver not to open or close (as the case may be) shades 450 or covers 510,610.

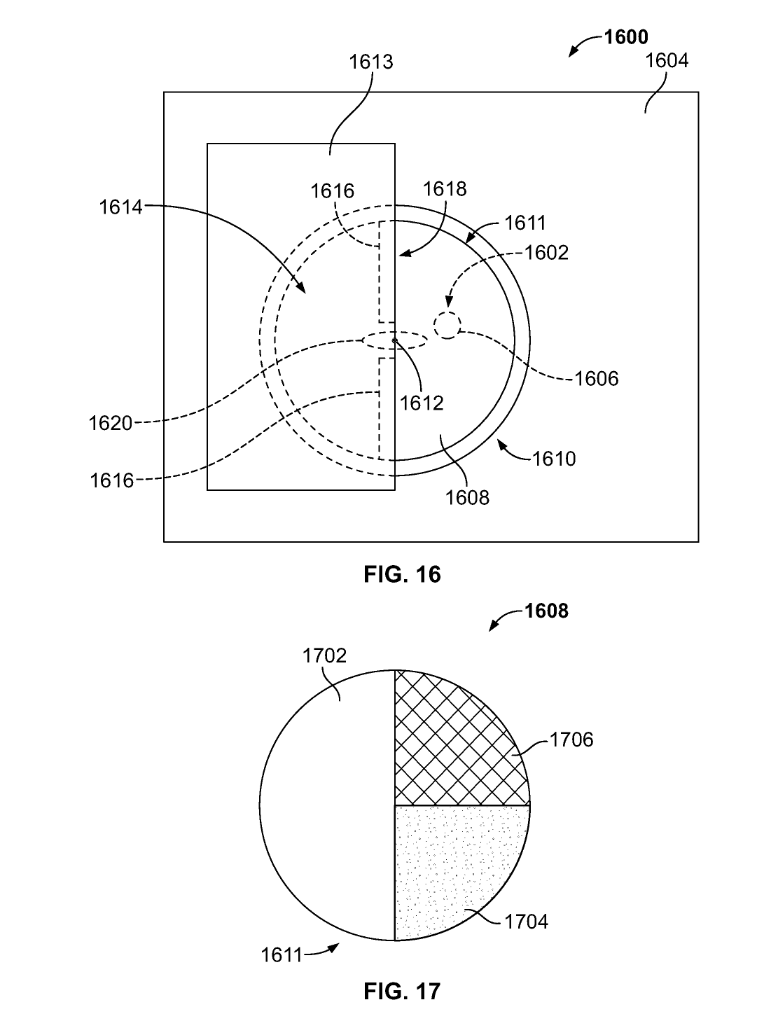

FIG. 16 illustrates another example camera cleaning and protection system 1600 of the instant disclosure. The system 1600 includes a camera 1602 located along an outer surface 1604 of the vehicle 100. The camera 1602 of the illustrated example includes a lens 1606. Further, the system 1600 includes a cover 1608 that covers the lens 1606 of the camera 1602. In the illustrated example, the cover 1608 is a disc.

Further, the lens 1606 and the cover 1608 of the illustrated example are at least partially positioned within a cavity 1610 defined by the outer surface 1604 of the vehicle 100. For example, the lens 1606 and the cover 1608 are positioned within the cavity 1610 for protection from foreign objects. In other examples, the lens 1606 and/or the cover 1608 are not positioned within a cavity (e.g., the cavity 1610) defined by the outer surface 1604 of the vehicle 100.

In the illustrated example, the cover 1608 includes a transparent segment 1611 through which light travels to the lens 1606 of the camera 1602. The transparent segment 1611 may include a filtering segment (e.g., a filtering segment 1704 of FIG. 4) that filters the light received via the lens 1606 and/or a clear segment (e.g., a clear segment 1702 of FIG. 7) that does not filter the light received via the lens 1606. Further, in some examples, the transparent segment 1611 is a fraction of the cover 1608. In other examples, the transparent segment 1611 is an entirety of the cover 1608.

The motor 420 actuates the cover 1608 to adjust which segment of the cover 1608 (e.g., the clear segment 1702, the filtering segment 1704, an opaque segment 1706 of FIG. 17) covers the lens 1606 of the camera 1602. For example, the motor 420 rotates the cover 1608 about an axis 1612 to adjust which segment of the cover 1608 covers the lens 1606. In some examples, the controller 210 controls operation of the motor 420 for actuating the cover 1608. For example, the controller 210 determines how to actuate the cover 1608 via the motor 420 based on light and/or weather conditions of surrounding the vehicle 100.

As illustrated in FIG. 16, the system 1600 also includes a panel 1613 that covers a covered portion 1614 of the cover 1608 that is offset from the lens 1606 of the camera 1602. For example, the panel 1613 is coupled to the outer surface 1604 of the vehicle 100. In other examples, the panel 1613 is integrally formed with the outer surface 1604 to form a portion of the outer surface 1604. In the illustrated example, the system 1600 includes one or more wipers 1616 are coupled to an interior surface 1618 of the panel 1613. The wipers 1616 are coupled to the panel 1613 such that the wipers 1616 engage a portion of the cover 1608. For example, as the motor 420 causes the cover 1608 to actuate, the wipers 1616 clean the cover 1608 by brushing material off of the cover 1608 to enable the lens 1606 to receive light through the cover 1608. Further, in the illustrated example, a heating element 1620 is embedded within the cover 1608 that is capable of defogging and/or defrosting the cover 1608 in various weather conditions.

FIG. 17 further illustrates the cover 1608 of the camera cleaning and protection system 1600. The cover 1608 of the illustrated example includes a clear segment 1702, a filtering segment 1704, and an opaque segment 1706. For example, the transparent segment 1611 of the cover 1608 includes the clear segment 1702 and the filtering segment 1704. The filtering segment 1704 filters and/or otherwise affects the light captured by the lens 1606 of the camera 1602, and the clear segment does not filter the light captures by the lens 1606. For example, the filtering segment 1704 includes a polarizing filter (e.g., a linear polarizer, a circular polarizer) that enables light wavelengths in some orientations to pass through to the lens 1606 and prevents other light wavelengths in other orientations from passing through to the lens 1606 of the camera 1602. In other examples, the filtering segment includes another type of filter (e.g., an NR cut filter, an NR pass filter, etc.). Further, the opaque segment 1706 of the illustrated example prevents the lens 1606 of the camera 1602 from capturing images of a surrounding area of the vehicle 100. In operation, the controller 210 identifies a selected segment of the cover 1608 and is to send a signal to the motor 420 to position the selected segment to cover the lens 1606 of the camera 1602.

In the illustrated example, the clear segment 1702 is about half of the cover 1608, the filtering segment 1704 is about a quarter of the cover 1608, and the opaque segment 1706 is about a quarter of the cover 1608. In other examples, the portion of the cover 1608 for each of the corresponding segments may vary. Further, in other examples, the cover 1608 may include more or less different types of segments. For example, the cover 1608 may include a plurality of different filtering segments.

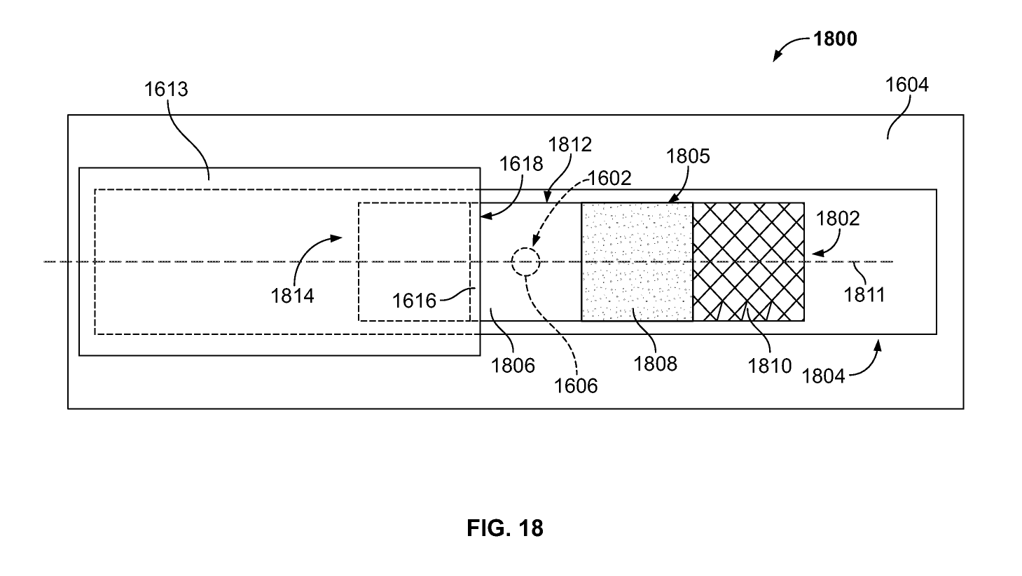

FIG. 18 illustrates another example camera cleaning and protection system 1800 of the instant disclosure. The system 1800 includes the camera 1602 that is located along the outer surface 1604 of the vehicle 100. Further, the system 1600 includes a cover 1802 that covers the lens 1606 of the camera 1602. In the illustrated example, the cover 1802 is a slide.

The lens 1606 and the cover 1802 of the illustrated example are at least partially positioned within a cavity 1804 defined by the outer surface 1604 of the vehicle 100. In other examples, the lens 1606 and/or the cover 1802 are not positioned within a cavity (e.g., the cavity 1804) defined by the outer surface 1604 of the vehicle 100.

In the illustrated example, the cover 1802 includes a transparent portion 1805 through which light travels to the lens 1606 of the camera 1602. The transparent portion 1805 includes a clear segment 1806 and a filtering segment 1808. In some examples, the transparent segment 1611 is a fraction of the cover 1608. Further, the cover 1802 of the illustrated example includes opaque segment 1810. In other examples, the transparent segment 1611 is an entirety of the cover 1608. The motor 420 actuates the cover 1802 to adjust which segment of the cover 1802 covers the lens 1606 of the camera 1602. For example, the motor 420 slides the cover 1802 along an axis 1811 to adjust which segment of the cover 1802 covers the lens 1606. The controller 210 identifies a selected segment 1812 of the cover 1802 and is to send a signal to the motor 420 to position the selected segment 1812 to cover the lens 1606 of the camera 1602.

As illustrated in FIG. 18, the system 1800 also includes the panel 1613 that covers a covered portion 1814 of the cover 1802 that is offset from the lens 1606 of the camera 1602. For example, the panel 1613 is coupled to the outer surface 1604 of the vehicle 100. In other examples, the panel 1613 is integrally formed with the outer surface 1604 to form a portion of the outer surface 1604. In the illustrated example, the system 1600 includes the one or more wipers 1616 are coupled to the interior surface 1618 of the panel 1613. For example, the wipers 1616 are coupled to the panel 1613 such that the wipers 1616 engage a portion of the cover 1608. For example, as the motor 420 causes the cover 1608 to actuate, the wipers 1616 clean the cover 1608 by brushing material off of the cover 1608 to enable the lens 1606 to receive light through the cover 1608.

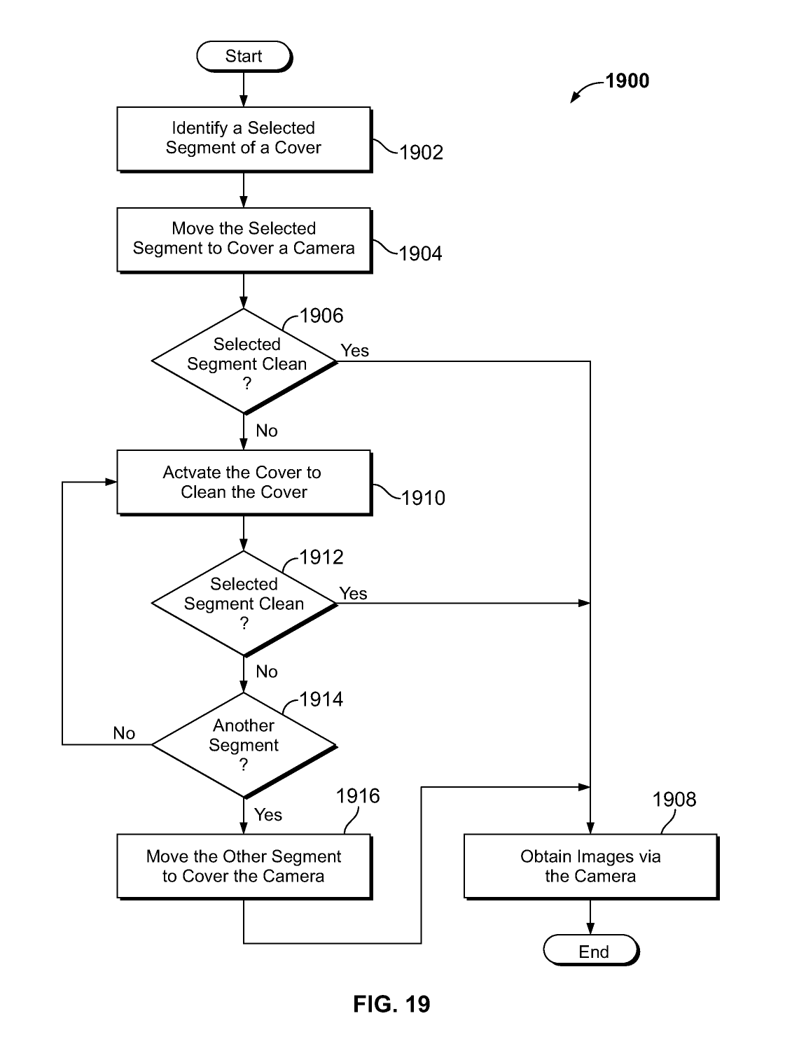

FIG. 19 illustrates a schematic view showing one or more modes of operation of the camera cleaning and protection system 1600 of FIGS. 16-17 and/or the camera cleaning and protection system 1600 of FIG. 18. That is, FIG. 19 is a flowchart of an example method 1900 to adjust a cover of a camera cleaning and protection system. The flowchart of FIG. 1900 is representative of machine readable instructions that are stored in memory and include one or more programs which, when executed by a processor (such as the controller 210 of FIG. 2), cause the vehicle 100 to adjust a cover of a camera cleaning and protection system. While the example program is described with reference to the flowchart illustrated in FIG. 19, many other methods of adjusting a cover of a camera cleaning and protection system may alternatively be used. For example, the order of execution of the blocks may be rearranged, changed, eliminated, and/or combined to perform the method 1900. Further, because the method 1900 is disclosed in connection with the components of FIGS. 2, 7, 11, and 16-18, some functions of those components will not be described in detail below.

Initially, at block 1902, the controller 210 identifies a selected segment (e.g., the selected segment 1812 of FIG. 18) of a cover (e.g., the cover 1608 of FIGS. 16-17, the cover 1802 of FIG. 18). For example, the controller 210 determines whether to cover the lens 1606 of the camera 1602 with a filtering segment (e.g., the filtering segment 1704 of FIG. 17, the filtering segment 1808 of FIG. 18), a clear segment (e.g., the clear segment 1702 of FIG. 17, the filtering segment 1808 of FIG. 18), or an opaque segment (e.g., the opaque segment 1706 of FIG. 17, the opaque segment 1810 of FIG. 18) based upon current motive functions of the vehicle 100, light conditions surrounding the vehicle 100, and/or weather conditions. At block 1904, the controller 210 moves the selected segment to cover the lens 1606 of the camera 1602 via the motor 420.

At block 1906, the controller 210 determines whether the selected segment of the cover is clean. For example, the controller 210 determines whether the selected segment is clean based upon an inspection image that captured by the camera 1602 while the selected segment is covering the lens 1606 of the camera 1602. In response to the controller 210 determining that the selected segment is clean, the method 1900 proceeds to block 1908 at which the camera 1602 captures images of a surrounding area of the vehicle 100. Otherwise, in response to the controller 210 determining that the selected segment is not clean, the method 1900 proceeds to block 1910.

At block 1910, the controller 210 actuates (e.g., rotates, slides) the cover, via the motor 420, to clean the cover via wiper(s) (e.g., the one or more wipers 1616 of FIGS. 16 and 18). At block 1912, the controller 210 determines whether the selected segment of the cover is clean. In response to the controller 210 determining that the selected segment is clean, the method 1900 proceeds to block 1908 at which the camera 1602 captures images of a surrounding area of the vehicle 100. Otherwise, in response to the controller 210 determining that the selected segment is not clean, the method 1900 proceeds to block 1914.

At block 1914, the controller 210 determines whether there is another segment available through which the camera is capable of capturing images. In response to the controller 210 determining that there is not another segment, the method 1900 returns to block 1910 to actuate the cover until the cover is clean. In response to the controller 210 determining that there is another segment, the method 1900 proceeds to block 1916 at which the controller 210 actuates the cover to position the other segment to cover the lens 1606 of the camera 1602. Upon performing block 1916, the method proceeds to block 1908 at which at which the camera 1602 captures images of a surrounding area of the vehicle 100.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. A vehicle camera system comprising:
a camera including a lens;
a cover for the lens that includes a transparent segment through which light travels to the camera;
a motor for actuating the cover to adjust which segment of the cover covers the lens;
a panel covering a portion of the cover offset from the lens; and
a wiper coupled to an interior surface of the panel for cleaning the cover as the cover actuates.

2. The system of claim 1, wherein the panel forms a portion of an outer surface of a vehicle.

3. The system of claim 1, wherein the cover is a disc.

4. The system of claim 1, wherein the motor rotates the cover about an axis to adjust which segment of the cover covers the lens of the camera.

5. The system of claim 1, wherein the cover is a slide.

6. The system of claim 1, wherein the motor slides the cover along an axis to adjust which segment of the cover covers the lens of the camera.

7. The system of claim 1, further including a controller for controlling operation of the motor.

8. The system of claim 1, further including a heating element embedded within the cover for defrosting or defogging the cover.

9. The system of claim 1, wherein the transparent segment of the cover includes a filtering segment that affects light captured by the lens of the camera.

10. The system of claim 9, wherein the filtering segment includes a polarizing filter that enables light wavelengths in some orientations to pass through to the lens of the camera and prevents other light wavelengths in other orientations from passing through to the lens of the camera.

11. The system of claim 1, wherein the transparent segment includes a clear segment that does not filter light captured by the lens of the camera.

12. The system of claim 1, wherein the cover includes:
a filtering segment that filters light captured by the lens of the camera;
a clear segment that that does not filter light captured by the lens of the camera; and
an opaque segment that prevents the camera from capturing images of a surrounding area.

13. The system of claim 12, wherein the filtering segment is about a quarter of the cover, the clear segment is about half the cover, and the opaque segment is about a quarter of the cover.

14. The system of claim 12, further including a controller to:
identify a selected segment from the filtering segment, the clear segment, and the opaque segment; and
send a signal to the motor to position the selected segment to cover the lens of the camera.

15. A method for controlling vehicle camera systems, comprising:
determining, via a processor, whether a cover is clean based upon an inspection image captured by a camera, the cover including a transparent segment through which light travels;
responsive to determining the cover is not clean, actuating the cover via a motor to facilitate a wiper contacting the cover to clean the cover; and
responsive to determining the cover is clean, capturing images via the camera.

16. The method of claim 15, wherein actuating the cover includes rotating the cover about an axis, the cover being a disc.

17. The method of claim 15, wherein actuating the cover includes sliding the cover along an axis, the cover being a slide.

18. The method of claim 15, further including actuating the cover until the cover is clean.

19. The method of claim 15, further including actuating the cover to cover a lens of the camera with a filtering segment, a clear segment, or an opaque segment of the cover, the transparent segment of the cover including the filtering segment and the clear segment.

20. The method of claim 19, further including determining, via the processor, whether to cover the lens of the camera with the filtering segment, the clear segment, or the opaque segment based upon at least one of current motive functions of a vehicle, light conditions surrounding the vehicle, and weather conditions.
